(19) United States
(12) Patent Application Publication
(10) Pub. No.: US 2008/0192140 A1
(43) Pub. Date: Aug. 14, 2008

(54) SELECTIVE CONTROL OF DISPLAY BRIGHTNESS LEVEL FOR FINE TO COARSE CONTROL

(75) Inventors: Jaeik Lee, Round Rock, TX (US); James Dailey, Round Rock, TX (US); Adolfo Montero, Pflugerville, TX (US)

Correspondence Address: HAYNES AND BOONE, LLP, 901 Main Street, Suite 3100, Dallas, TX, 75202, US

(73) Assignee: DELL PRODUCTS L.P., Round Rock, TX (US)

(21) Appl. No.: 11/674,591

(22) Filed: Feb. 13, 2007

(51) Int. Cl. H04N 5/235

(52) U.S. Cl. 348/362; 348/E05.038

(57) ABSTRACT

A method for operating an informational handling system includes providing a user control for allowing a user to select a granularity between a plurality of brightness steps, detecting the selected granularity based on input from the user control, and implementing the selected granularity.

### BACKGROUND

The present disclosure relates generally to information handling systems and specifically to information handling system display devices.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Some IHSs utilize display devices as an interface between the IHS and the user. It is common for an IHS such as, for example, a notebook computer to include a display device such as, for example, a liquid crystal display (LCD). Conventionally, IHSs offer a fixed number of brightness options for a display device that a user may select from. If the number of brightness options is too low, it can result in skipping over a brightness setting that is desired. If the number of brightness options is too high, it can result in the user being required to cycle through a large number of brightness options in order to get to the preferred brightness setting.

Accordingly, it would be desirable to provide for enhanced display brightness control absent the disadvantages found in the prior methods discussed above.

### SUMMARY

According to one embodiment, a method for operating an IHS includes providing a user control for allowing a user to select a granularity between a plurality of brightness steps, detecting the selected granularity based on input from the user control, and implementing the selected granularity.

### BRIEF DESCRIPTION OF THE DRAWINGS

FIG. 1 is a block diagram illustrating an embodiment of an IHS.

FIG. 2 depicts an embodiment of an initial panel characterization table.

FIG. 3 contains an embodiment of a characterization graph.

FIG. 4 illustrates an embodiment of a characterization graph.

FIG. 5 contains an embodiment of a panel characterization table.

FIG. 6 shows an embodiment of a panel characterization table.

FIG. 7 illustrates an embodiment of a panel characterization table.

FIG. 8 depicts an embodiment of a characterization graph.

FIGS. 9 and 10 illustrate embodiments of display device information stored in a computer readable medium.

FIG. 11 depicts an embodiment of a flowchart for a method of characterizing a display device.

FIGS. 12a, 12b, 13a, 13b, 14a, 14b, 15a, 15b, 16a and 16b illustrate embodiments of user controls for allowing a user to select a granularity.

FIG. 17 illustrates an embodiment of a method for operating an IHS.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

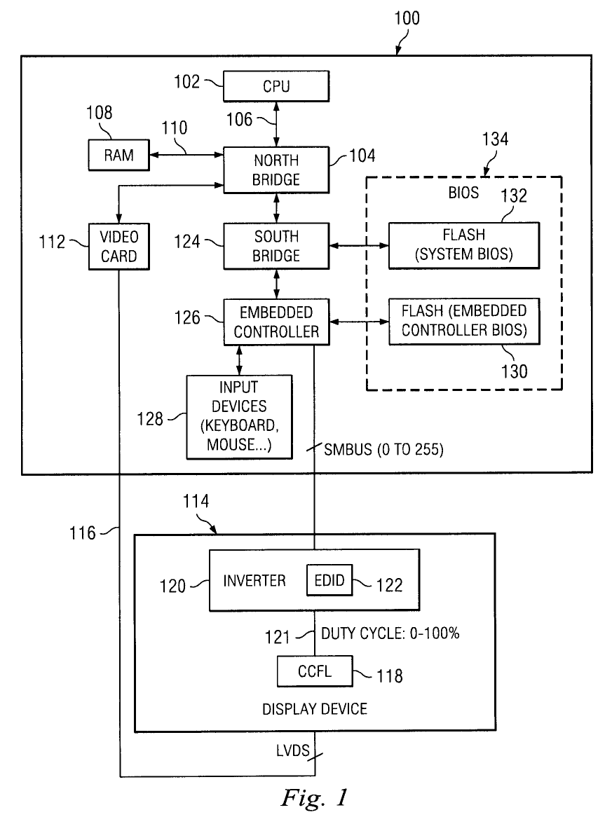

FIG. 1 is a block diagram of an embodiment of an IHS. The IHS 100 includes a processor 102 such as an Intel Pentium series processor or one of many other processors currently available. A northbridge 104 couples to the processor 102 over a bus 106 and acts as a host controller that communicates with the processor 102. Main memory 108 also connects to the northbridge 104 over a memory bus 110, and the northbridge 104 further acts as a controller for main memory 108. A video card 112 couples to the northbridge 104, allowing the video card 112 to communicate, e.g., with the processor 102 and main memory 108. The video card 112 is also coupled to a display device 114 over low voltage differential signaling (LVDS) 116 to provide display signals to the display device 114. The display device 114 includes a cold-cathode fluorescent lamp (CCFL) 118 to light up the display device 114. The display device 114 also includes an inverter 120 to convert direct current (DC) to alternating current (AC) and send pulse-width modulation (PWM) duty cycle 121 values to the CCFL 118. The inverter 120 includes an extended display identification data (EDID) 122 to describe the display device's 114 capabilities to the IHS 100.

A southbridge 124 is coupled to the northbridge 104. An embedded controller 126 is coupled to the southbridge 124 to provide connectivity to input devices 128. Examples of input devices 128 include keyboards, touchscreens, and pointing devices such as mouses, trackballs and trackpads. The embedded controller is coupled to an embedded controller BIOS 130 and the southbridge 124 is coupled to a system BIOS 132. The embedded controller BIOS 130 and the system BIOS 132 together form the BIOS 134. The embedded controller 126 is coupled to a System Management Bus (SMBus) 136, which is coupled to the inverter 120.

Not all IHSs include each of the components shown in FIG. 1, and other components not shown may exist. Furthermore, some components shown as separate may exist in an integrated package or be integrated in a common integrated circuit with other components. As can be appreciated, many systems are expandable, and include or can include a variety of components, including redundant or parallel resources.

One physical configuration for an IHS 100 is as a laptop computer. Such laptop computers typically combine the processing components of IHS 100 with a battery in a common case to provide a device that can be easily transported and used almost anywhere. A brightness level of the display device 114 may be adjusted by a user. The user may desire to adjust the brightness level depending on ambient lighting conditions or to save power. Additionally, the user may desire either to have fine control of the brightness level or to have coarse control of the brightness level, depending on the user's preference and/or current application. As such, it would be beneficial for the user to have the ability to select a total number of brightness options that the user may have to select from.

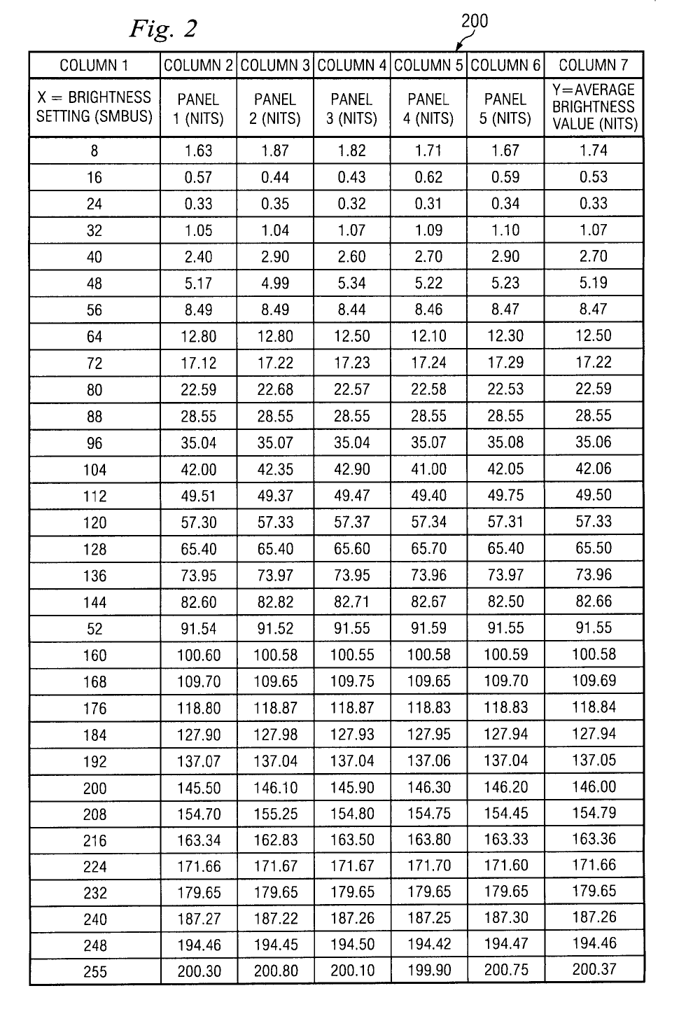

Referring now to FIG. 2, an embodiment of an initial panel characterization table is depicted. The table 200 shows a brightness value output in nits for five panels in response to a variety of brightness settings being provided from the embedded controller 126 to the inverter 120 over the SMBus 136. A nit is a unit of luminance that represents a candela per meter squared. Column 1 illustrates the brightness settings provided from the embedded controller 126 to the inverter 120 over the SMBus 136. Columns 2, 3, 4, 5 and 6 show the respective brightness values for Panels 1, 2, 3, 4 and 5 corresponding to the brightness settings provided in Column 1. Column 7 shows the average brightness value in nits of the five panels corresponding to the brightness settings provided.

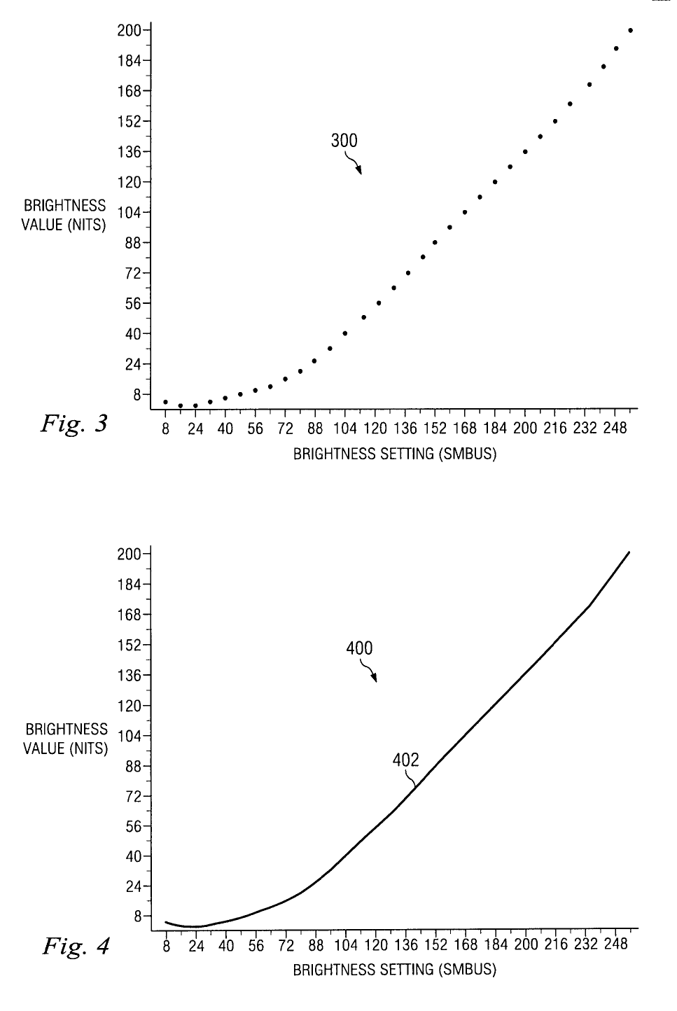

Referring now to FIG. 3, an embodiment of an initial panel characterization graph is shown. Brightness settings are represented by an X-axis and brightness values are represented by a Y-axis on the graph 300. There are 32 points marked to illustrate the average brightness values from Column 7 of FIG. 2 that correspond to the 32 brightness settings listed in Column 1 of FIG. 2.

Referring now to FIG. 4, an embodiment of a characterization graph is illustrated. The graph 400 shows a curve that corresponds to the 32 points marked in FIG. 3. A mathematical optimization technique, such as ordinary least squares, can be used to find a formula 402 which closely approximates the data. The formula 402 for a best fitting function of the illustrated curve is y=−165E−7x̂3+860E−5x̂2−350E−3x+4.

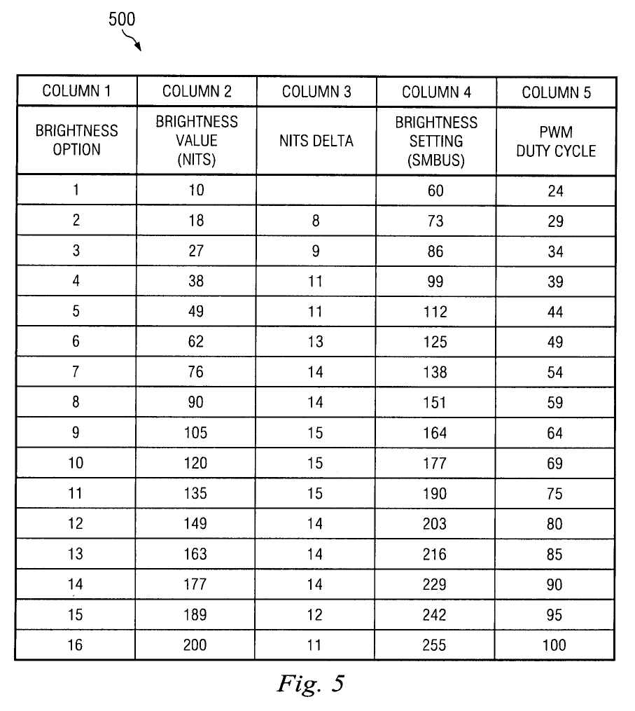

Referring now to FIG. 5, an embodiment of a panel characterization table is shown. Column 1 of the table 500 shows brightness options. Column 2 indicates the brightness value in nits given off by the display device 114 when provided the brightness option number given in Column 1. Column 3 indicates a nits delta. The nits delta is determined by subtracting the brightness value in nits corresponding to the previous brightness option from the brightness value in nits corresponding to the current brightness option. Column 4 shows brightness settings necessary to be provided over the SMBus 136 to achieve the listed brightness values. In this embodiment the brightness settings provided increment linearly. Column 5 illustrates a PWM duty cycle 121 corresponding to the brightness settings.

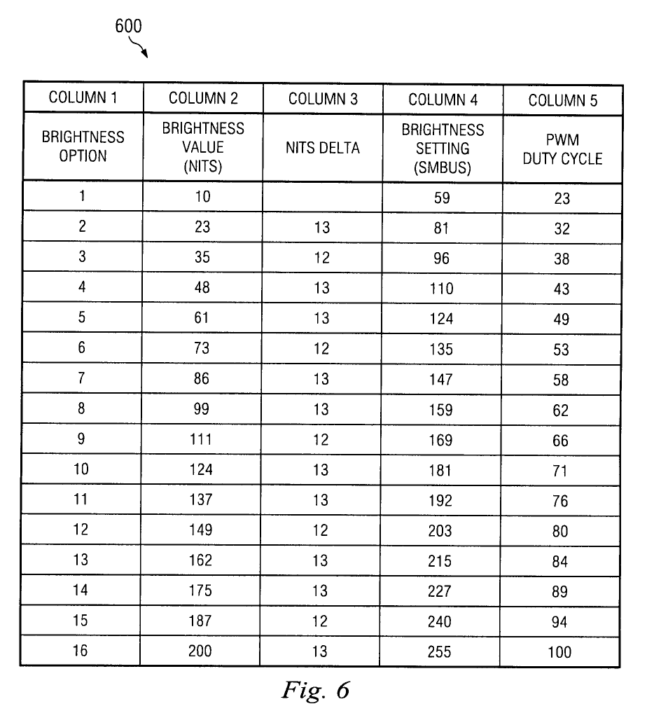

Referring now to FIG. 6, an embodiment of a panel characterization table is depicted. Column 1 of table 600 shows brightness options. Column 2 indicates the brightness value in nits given off by the display device 114 when provided the brightness option given in Column 1. In this embodiment the brightness values increment linearly. Column 3 indicates a nits delta. The nits delta is determined by subtracting the brightness value in nits corresponding to the previous brightness option from the brightness value in nits corresponding to the brightness option. Column 4 shows brightness settings necessary for providing the desired brightness values. Column 5 illustrates the PWM duty cycle value 121 corresponding to the brightness settings.

Referring now to FIG. 7, an embodiment of a panel characterization table is illustrated. Column 1 of table 700 shows brightness options. Column 2 indicates the brightness values in nits given off by the display device 114 when provided the brightness option given in Column 1. In this embodiment the brightness values increment exponentially. Column 3 indicates a nits delta. The nits delta is determined by subtracting the brightness value in nits corresponding to the previous brightness option from the brightness value in nits corresponding to the current brightness option. In this embodiment the brightness will appear to the user to increase linearly, because the nits values increment exponentially. Human eyes perceive a magnitude of the nits delta as a percentage of the nits value prior to the adjustment. That is, a 20% adjustment from 100 nits to 120 nits will be perceived by the human eye to be an adjustment of the same magnitude as a 20% adjustment from 200 nits to 240 nits, even though the nits delta is actually 20 nits in the first scenario and 40 nits in the second scenario. Column 4 shows brightness settings necessary for producing the desired brightness values. Column 5 illustrates the PWM duty cycle values 121 corresponding to the brightness settings.

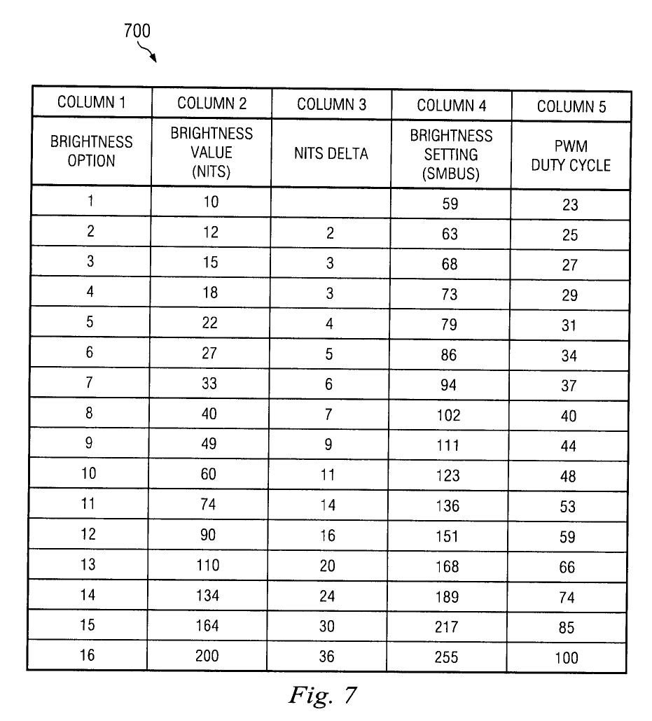

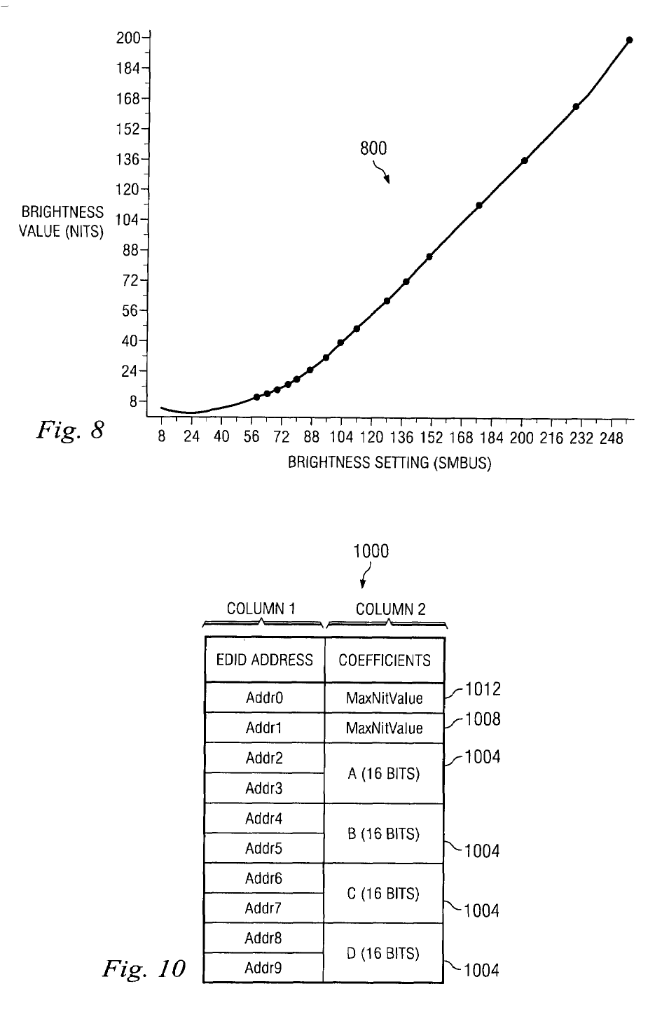

Referring now to FIG. 8, an embodiment of a characterization graph is depicted. Brightness settings are represented by an X-axis and brightness values are represented by a Y-axis. This graph corresponds to the table of FIG. 7. There are 16 points marked to illustrate the brightness values from Column 2 of FIG. 7 that correspond to the brightness settings listed in Column 4 of FIG. 7. In this embodiment the brightness values increment exponentially and the brightness level will appear to the user to increase linearly. This is because human eyes perceive the magnitude of the nits delta as a percentage of the nits value prior to the adjustment.

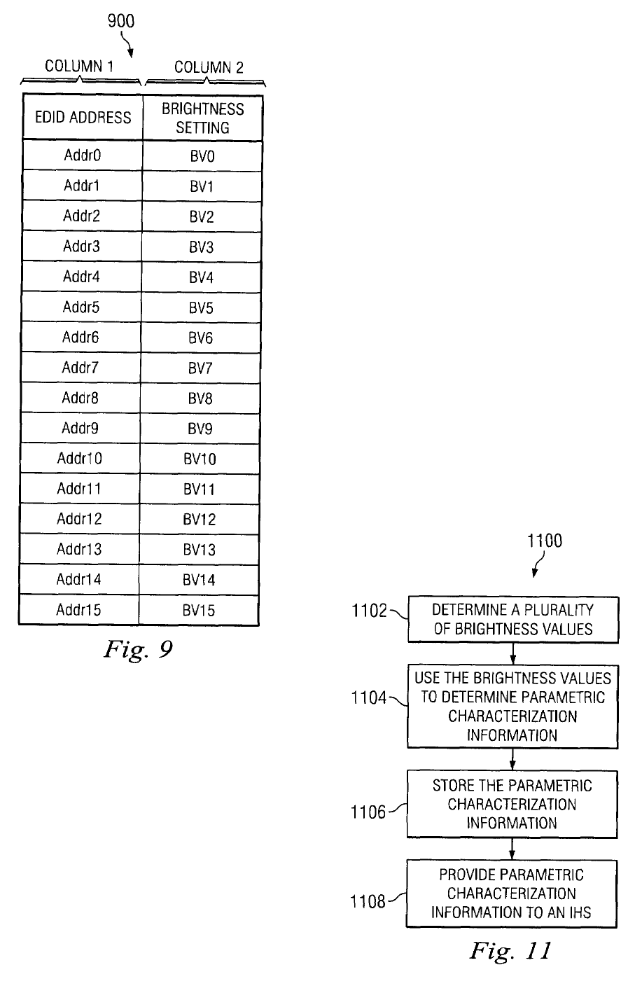

Referring now to FIG. 9, an embodiment of display device information stored in a computer readable medium is illustrated. Column 1 indicates an address for each of 16 steps. Column 2 includes a brightness value corresponding to each step. The brightness values may be measured in units of luminance such as, for example, candelas per meters squared (nits) or candelas per centimeters squared (stilbs).

Referring now to FIG. 10, an embodiment of display device information stored in a computer readable medium is shown. Column 1 indicates ten addresses of the EDID 122. Column 2 includes parametric characterization information indicating the display device 114 capabilities. The parametric characterization information shown indicates coefficients 1004 for a function y=−Ax̂3+Bx̂2Cx+D. For example, for the formula 402 illustrated in FIG. 4, y=−165E−7x̂3+860E−5x̂2−350E−3x+4, the coefficients 1004 would be A=165E−7, B=860E−5, C=350E−3, and D=4. The parametric characterization information further includes a minimum brightness value 1008 of the display device 114 and a maximum brightness value 1012 of the display device 114, represented by MinNitValue=10 and MaxNitValue=200, respectively.

Referring now to FIG. 11, an embodiment of a flowchart for a method of characterizing a display device 114 is depicted. Method 1100 begins with step 1102, determining a plurality of brightness values, wherein each one of the brightness values has a corresponding brightness setting. The method 1100 then proceeds to step 1104, using the brightness values to determine parametric characterization information. The parametric characterization information includes coefficients 1004 for the formula 402. In one embodiment, it is envisioned that the formula 402 is standardized among display device 114 providers. The method 1100 then proceeds to step 1106 of storing the parametric characterization information in a computer readable medium such as, for example, the EDID 122. The method 1100 then proceeds to step 1108 where the parametric characterization information is provided to the IHS.

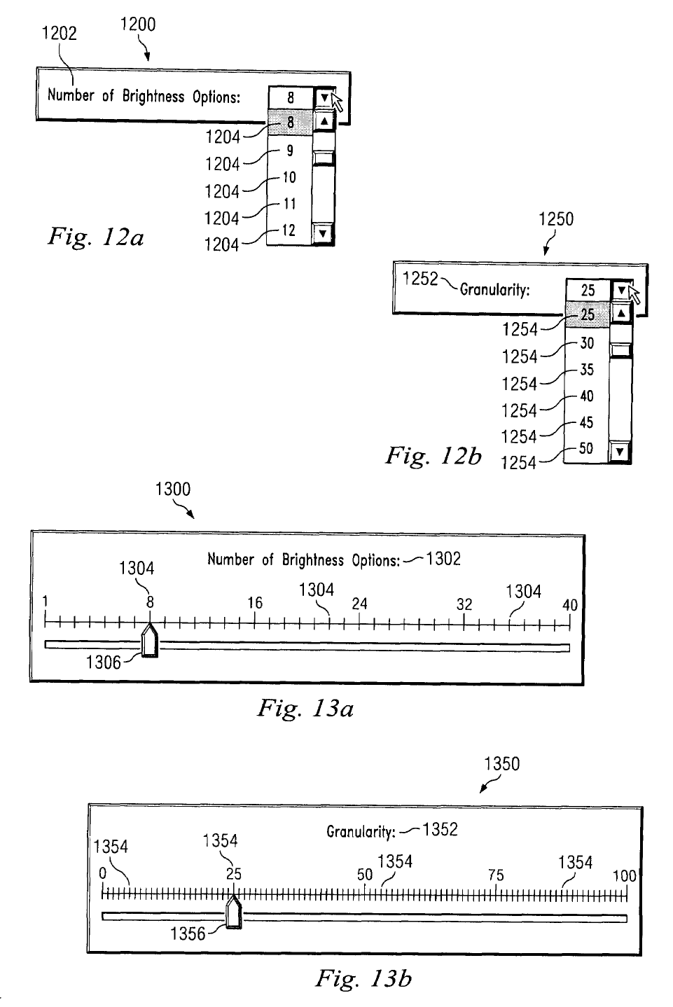

Referring now to FIGS. 12a and 12, embodiments of a user control for allowing the user to select a granularity are depicted. FIG. 12a illustrates a user control for allowing the user to select a desired number of brightness options from a graphical user interface (GUI) drop-down menu. The GUI drop-down menu 1200 includes a heading 1202 to communicate to the user that the user may select a “Number of Brightness Options.” The user may utilize one of the input devices 128 to select one of a plurality of values 1204 for the number of total brightness options. FIG. 12b depicts a user control for allowing the user to select a desired number corresponding to a granularity from a GUI drop-down menu. The GUI drop-down menu 1250 includes a heading 1252 to communicate to the user that the user may select a “Granularity.” The user may utilize one of the input devices 128 to select one of a plurality of granularity options 1254.

FIG. 13a shows a user control for allowing the user to select the desired number of brightness options using a GUI sliding bar. The GUI slider bar 1300 includes a heading 1302 to communicate to the user that the user may select a “Number of Brightness Options.” The user may utilize one of the input devices 128 to select one of a plurality of values 1304 for the number of total brightness options using a slider 1306. FIG. 13b illustrates a user control for allowing the user to select the desired number corresponding to the granularity using a GUI sliding bar. The GUI sliding bar 1350 includes a heading 1352 to communicate to the user that the user may select a “Granularity.” The user may utilize one of the input devices 128 to select one of a plurality of granularity options 1354 using a slider 1356.

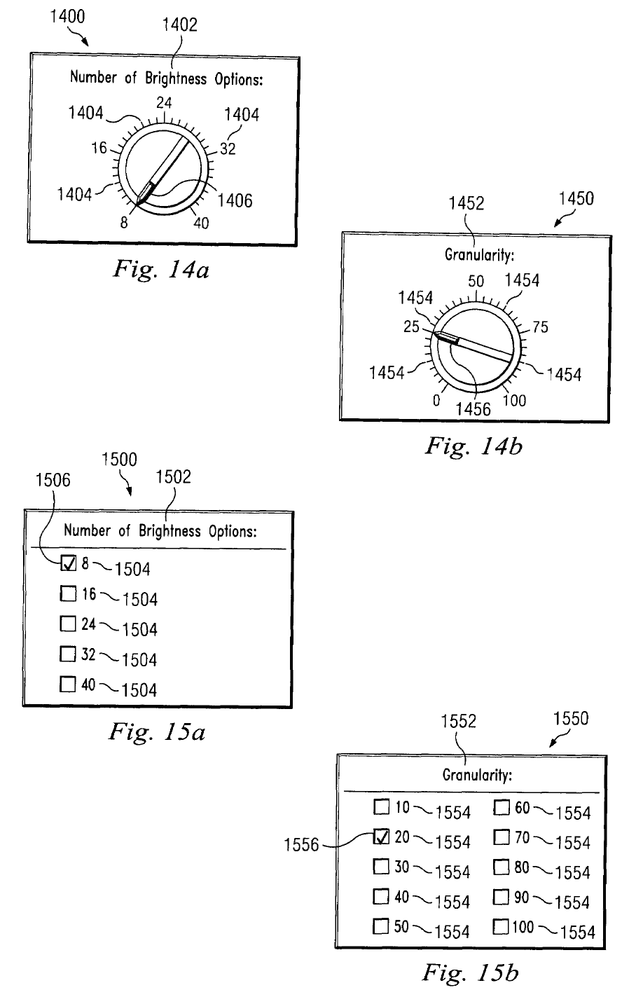

FIG. 14a illustrates a user control for allowing the user to select the desired number of brightness options using a GUI knob. The GUI knob 1400 includes a heading 1402 to communicate to the user that the user may select a “Number of Brightness Options.” The user may utilize one of the input devices 128 to select one of a plurality of values 1404 for the number of total brightness options using a knob 1406. FIG. 14b illustrates a user control for allowing the user to select the desired number corresponding to the granularity using a GUI knob. The GUI knob 1450 includes a heading 1452 to communicate to the user that the user may select a “Granularity.” The user may utilize one of the input devices 128 to select one of a plurality of granularity options 1454 using a knob 1456.

FIG. 15a depicts a user control for allowing the user to select the desired number of brightness options using GUI check boxes. The GUI check boxes 1500 includes a heading 1502 to communicate to the user that the user may select a “Number of Brightness Options.” The user may utilize one of the input devices 128 to select one of a plurality of values 1504 for the number of total brightness options by putting a check 1506 in a box next to a desired selection. FIG. 15b shows a user control for allowing the user to select the desired number corresponding to the granularity using GUI check boxes. The GUI check boxes 1550 includes a heading 1552 to communicate to the user that the user may select a “Granularity.” The user may utilize one of the input devices 128 to select one of a plurality of granularity options 1554 by putting a check 1556 in a box next to a desired selection.

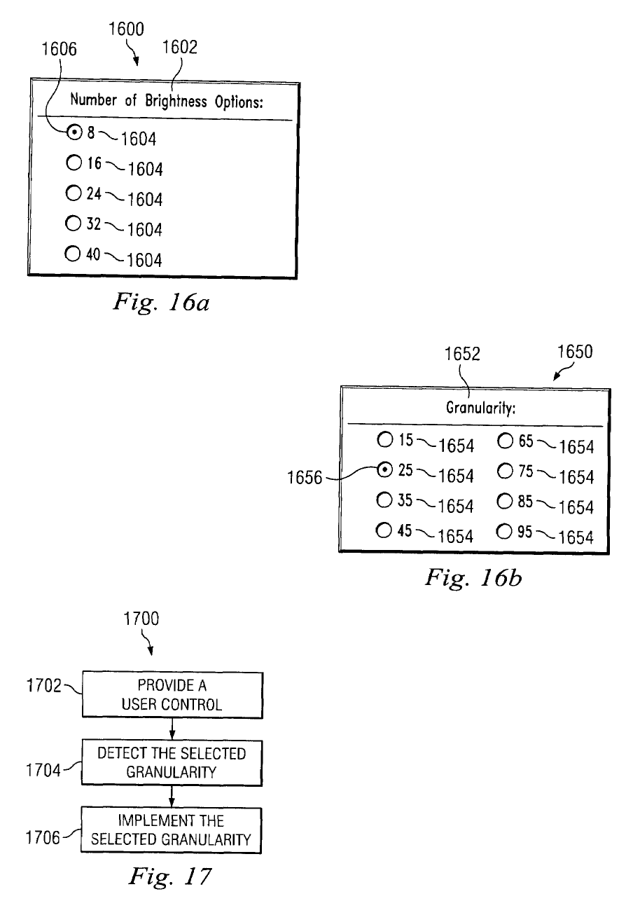

FIG. 16a depicts a user control for allowing the user to select the desired number of brightness options using GUI buttons. The GUI buttons 1600 includes a heading 1602 to communicate to the user that the user may select a “Number of Brightness Options.” The user may utilize one of the input devices 128 to select one of a plurality of values 1604 for the number of total brightness options by selecting a button 1606 next to a desired selection. FIG. 16b shows a user control for allowing the user to select the desired number corresponding to the granularity using GUI buttons. The GUI buttons 1650 includes a heading 1652 to communicate to the user that the user may select a “Granularity.” The user may utilize one of the input devices 128 to select one of a plurality of granularity options 1654 by selecting a button 1656 next to a desired selection.

Referring now to FIG. 17, an embodiment of a method 1700 for operating an IHS is illustrated. The method 1700 begins with step 1702, providing a user control for allowing the user to select the granularity between the plurality of brightness options. Examples of user controls include GUI drop-down menus, GUI check boxes, GUI knobs, configuration files, command lines, and physical user controls. The method 1700 then proceeds to step 1704, detecting the selected granularity based on input from the user control. The method 1700 then proceeds to step 1706, implementing the selected granularity. The EDID 122 contains the parametric characterization information as illustrated in FIG. 10. The processor 102 executes BIOS 134 instructions and retrieves the parametric characterization information from the EDID 122 and stores the parametric characterization information in the RAM 108 to use while executing the BIOS 134 instructions. When the user changes the selected granularity, the processor 102 will execute instructions in BIOS 134 to calculate the brightness values for each brightness option so that the brightness options are evenly spaced according to the human eye. The processor 102 will then execute instructions in BIOS 134 to determine the brightness settings corresponding to each of the brightness options using the corresponding brightness values as well as the coefficients 1004, the minimum brightness value 1008, and the maximum brightness value 1012 stored in the RAM 108. The brightness settings will be stored in the RAM 108.

After the brightness settings have been calculated and stored the user may select a desired brightness option. The brightness setting in the RAM 108 corresponding to the desired brightness option will be sent from the embedded controller 126 across the SMBus 136 to the inverter 120 in the display device 114. The brightness setting will be between 0 to 255. The inverter 120 will divide the brightness setting by 255 to determine the PWM duty cycle value 121 of the signal. The PWM duty cycle value 121 will be sent from the inverter 120 to the CCFL 118. The higher the PWM duty cycle value 121, the more light the CCFL 118 will emit to light up the display device 114.

Although illustrative embodiments have been shown and described, a wide range of modification, change and substitution is contemplated in the foregoing disclosure and in some instances, some features of the embodiments may be employed without a corresponding use of other features. For example, in another embodiment the formula 402 may not be standardized among the display device 114 providers. In such an embodiment, the parametric characterization information will indicate the formula 402 that signifies the capabilities of the display device 114. Also, in another embodiment segments may be used to indicate the capabilities of the display device 114 instead of using the formula 402. Additionally, other embodiments may include a different number of brightness steps than those illustrated above. Furthermore, in another embodiment the brightness settings may be calculated each time the brightness option is changed. Accordingly, it is appropriate that the appended claims be construed broadly and in a manner consistent with the scope of the embodiments disclosed herein.

1. An information handling system (IHS) comprising:
a memory;
a processor coupled to the memory;
a display device coupled to the processor, wherein the display device is capable of exhibiting a plurality of brightness values;
a subsystem for providing a user control to allow a user to select a granularity between a plurality of brightness steps, wherein each one of the brightness steps has a corresponding brightness value; and
a subsystem for implementing the selected granularity on the display device.

2. The IHS of claim 1, wherein the user control is selected from the group consisting of one or more of a graphical user interface (GUI) drop-down menu, a GUI slider bar, GUI button, a GUI check box, a GUI knob, a physical user control, a configuration file, a command line, and any combination thereof.

3. The IHS of claim 1, wherein allowing the user to select the granularity comprises allowing the user to select a total number of brightness steps.

4. The IHS of claim 1, wherein implementing the selected granularity comprises storing a set of coefficients in the memory.

5. The IHS of claim 1, wherein an increase from a first brightness step to a second brightness step is a nonlinear increase.

6. The IHS of claim 5, wherein the nonlinear increase is based on an approximately fixed percentage increase from the first brightness step to the second brightness step.

7. A method of operating an information handling system (IHS), comprising:
providing a user control for allowing a user to select a granularity between a plurality of brightness steps;
detecting the selected granularity based on input from the user control; and implementing the selected granularity.

8. The method of claim 7, wherein each brightness step has a corresponding brightness value.

9. The method of claim 7, wherein the user control is selected from the group consisting of one or more of a graphical user interface (GUI) drop-down menu, a GUI slider bar, GUI button, a GUI check box, a GUI knob, a physical user control, a configuration file, a command line, and any combination thereof.

10. The method of claim 7, wherein allowing the user to select the granularity comprises allowing the user to select a total number of brightness options.

11. The method of claim 7, wherein implementing the selected granularity comprises storing a set of coefficients.

12. The method of claim 7, wherein a brightness increase from a first brightness step to a second brightness step is a nonlinear increase based on an approximately fixed percentage brightness increase from the first brightness step to the second brightness step.

13. A method for characterizing a display device, comprising:
determining a plurality of brightness values, wherein each one of the brightness values has a corresponding brightness setting;
using the plurality of brightness values to determine parametric characterization information; and
storing information for the parametric characterization information in a computer readable medium within the display device, the information accessible to an information handling system controlling display brightness.

14. The method of claim 13, further comprising:
providing the parametric characterization information to an IHS coupled to the display device to provide graphical output to the display device.

15. The method of claim 13, wherein the parametric characterization information indicates a formula corresponding to the display device capabilities.

16. The method of claim 13, further comprising:
using the parametric characterization information to generate a plurality of brightness steps.

17. The method of claim 16, wherein each one of the brightness steps has a corresponding brightness value.

18. The method of claim 13, wherein the parametric characterization information comprises a minimum brightness value of the display device and a maximum brightness value of the display device.

19. The method of claim 13, wherein the parametric characterization information comprises coefficients for a formula.

20. The method of claim 16, wherein a user may select a granularity between the brightness steps.

21. The method of claim 16, wherein the plurality of brightness steps increment nonlinearly from at least a first brightness step to a second brightness step.

22. The method of claim 18, wherein the minimum brightness value and the maximum brightness value are expressed in nits.
